(19) United States
(12) Patent Application Publication
(10) Pub. No.: US 2016/0065512 A1
(43) Pub. Date: Mar. 3, 2016

(54) Media, Systems, Networks, And Methods For Broadcasting Audio Messages Through A Social Networking Site

(71) Applicant: Song-i Ltd, London (GB)

(72) Inventor: Artem B. Voskoboynikov, Moscow (RU)

(73) Assignee: Song-i Ltd, London (GB)

(21) Appl. No.: 14/475,996

(22) Filed: Sep. 3, 2014

(51) Int. Cl. H04L 12/58; H04L 29/06; G06F 3/16; G06F 3/0484

(52) U.S. Cl. CPC H04L 51/10; G06F 3/04847; G06F 3/04842; H04L 51/32; H04L 65/4076; G06F 3/165

(57) ABSTRACT

Non-transitory computer readable storage medium can include a set of executable instructions to direct a processor to record one or more audio messages from a member of a social networking site. The audio message(s) can be stored in a library accessible only to the member. A selection can be received from the member of at least one of the one or more audio messages from the library. The selected audio message(s) can be associated with an account of the member. The selected audio message(s) can be broadcasted from the account of the member to at least one user of the social networking site when the user accesses the account of the member. Systems, networks, and methods are also disclosed.

### BACKGROUND

1. Field of the Disclosed Subject Matter

The present disclosed subject matter relates to broadcasting audio messages, including broadcasting audio messages through a social networking site, for example, broadcasting audio messages to at least one user of the social networking site when the user accesses the account of a member of the social networking site.

2. Description of Related Art

Social networks can allow a member to create a semi-customizable profile page that can be tailored to reflect the member's personality and interests. A profile page can make an immediate statement about the member and can allow the member to project an identity. For example and not limitation, customization of profile pages can include the ability to create a personalized background of pictures, a choice of colors, and other prominent items. Additionally, members and other users can post items of interest to the member's profile page to highlight or reinforce the member's identity and interests.

Social networking sites can lack other forms of customization, for example, personalizing a profile page through the use of audio messages that can stream automatically when the profile page loads. As such, there remains a need for techniques for broadcasting audio messages through a social networking site.

### SUMMARY

The purpose and advantages of the disclosed subject matter will be set forth in and apparent from the description that follows, as well as will be learned by practice of the disclosed subject matter. Additional advantages of the disclosed subject matter will be realized and attained by the methods and systems particularly pointed out in the written description and claims hereof, as well as from the appended drawings.

To achieve these and other advantages and in accordance with the purpose of the disclosed subject matter, as embodied and broadly described, a non-transitory computer readable storage medium is disclosed. The non-transitory computer readable storage medium can include a set of executable instructions to direct a processor to record one or more audio messages from a member of a social networking site. The audio message(s) can be stored in a library accessible only to the member. A selection can be received from the member of at least one of the one or more audio messages from the library. The selected audio message(s) can be associated with an account of the member. The selected audio message(s) can be broadcasted from the account of the member to at least one user of the social networking site when the user accesses the account of the member.

As embodied herein, a request can be received from the member to record the audio message(s) before recording the audio message(s). For purpose of illustration and not limitation, receiving a request can include receiving an indication that the member has interacted with at least one element. For example and not limitation, the element can include at least one of a link, a button, an icon, or a keyboard.

For purpose of illustration and not limitation, consent can be received from the at least one user to broadcast the selected audio message(s). Additionally, consent can be received from the member to a license agreement. For example and not limitation, the license agreement can include at least one of a license for the member to use software to record and broadcast the audio messages and a license for the social networking site and a software provider to broadcast the audio messages. Additionally or alternatively, consent can be received from the at least one user to a license agreement.

As embodied herein, whether the audio message(s) include music can be detected. Additionally, broadcasting the selected audio message(s) can include broadcasting the selected audio message(s) if the selected at least one message does not include music. For example and not limitation, detecting whether the audio message(s) include music can include using voice recognition to determine whether the audio message(s) include music. Additionally or alternatively, playback of the selected audio message(s) can be prevented if the selected audio message(s) include music.

For purpose of illustration and not limitation, broadcasting the selected audio message(s) can include streaming the selected audio message(s) without downloading or permanently storing the selected audio message(s). Additionally or alternatively, downloading, copying or permanently storing the selected audio message(s) can be prevented. For example and not limitation, preventing downloading, copying, or permanently storing the audio message(s) can include using encryption.

As embodied herein, the selected audio message(s) can include a plurality of audio messages. Additionally, a selection of an order in which to broadcast the plurality of audio messages can be received from the member. Additionally or alternatively, a selection of a number of times to broadcast the selected audio message(s) can be received from the member.

In accordance with another aspect of the disclosed subject matter, a computer system for broadcasting audio messages is disclosed. The computer system can include at least one processor. A non-transitory computer readable medium can embody executable instructions that can be configured when executed by one or more of the at least one processor to record one or more audio messages from a member of a social networking site. The audio message(s) can be stored in a library accessible only to the member. A selection can be received from the member of at least one of the one or more audio messages from the library. The selected audio message(s) can be associated with an account of the member. The selected audio message(s) can be broadcasted from the account of the member to at least one user of the social networking site when the user accesses the account of the member.

In accordance with another aspect of the disclosed subject matter, a computer network for broadcasting audio messages is disclosed. The computer network can include a communication interface. One or more processors can be connected to the communication interface. One or more computer readable storage media can be connected to the communication interface and to one or more of the processors. The computer readable storage media can embody executable instructions that can be configured when executed by one or more of the processors to record one or more audio messages from a member of a social networking site. The audio message(s) can be stored in a library accessible only to the member. A selection can be received from the member of at least one of the one or more audio messages from the library. The selected audio message(s) can be associated with an account of the member. The selected audio message(s) can be broadcasted from the account of the member to at least one user of the social networking site when the user accesses the account of the member.

In accordance with another aspect of the disclosed subject matter, a method for broadcasting audio messages is disclosed. The method can include recording one or more audio messages from a member of a social networking site. The audio message(s) can be stored in a library accessible only to the member. A selection can be received from the member of at least one of the one or more audio messages from the library. The selected audio message(s) can be associated with an account of the member. The selected audio message(s) can be broadcasted from the account of the member to at least one user of the social networking site when the user accesses the account of the member.

It is to be understood that both the foregoing general description and the following detailed description are exemplary and are intended to provide further explanation of the disclosed subject matter claimed.

The accompanying drawings, which are incorporated in and constitute part of this specification, are included to illustrate and provide a further understanding of the disclosed subject matter. Together with the description, the drawings serve to explain the principles of the disclosed subject matter.

### BRIEF DESCRIPTION OF THE DRAWINGS

FIG. 1 is a diagram illustrating a representative system and a representative computer network according to an illustrative embodiment of the disclosed subject matter.

FIG. 2 is a flow chart illustrating a representative method implemented according to an illustrative embodiment of the disclosed subject matter.

FIG. 3 is a diagram illustrating further details of a representative system according to an illustrative embodiment of the disclosed subject matter.

### DETAILED DESCRIPTION OF THE PREFERRED EMBODIMENT

Reference will now be made in detail to the various exemplary embodiments of the disclosed subject matter, exemplary embodiments of which are illustrated in the accompanying drawings. The structure and corresponding method of operation of the disclosed subject matter will be described in conjunction with the detailed description of the system.

The media, systems, networks, and methods presented herein can be used for broadcasting audio messages. The disclosed subject matter is particularly suited for broadcasting audio messages through a social networking site, for example, broadcasting audio messages to at least one user of the social networking site when the user accesses the account of a member of the social networking site.

In accordance with the disclosed subject matter herein, a non-transitory computer readable storage medium is disclosed. The non-transitory computer readable storage medium can include a set of executable instructions to direct a processor to record one or more audio messages from a member of a social networking site. The audio message(s) can be stored in a library accessible only to the member. A selection can be received from the member of at least one of the one or more audio messages from the library. The selected audio message(s) can be associated with an account of the member. The selected audio message(s) can be broadcasted from the account of the member to at least one user of the social networking site when the user accesses the account of the member.

In accordance with another aspect of the disclosed subject matter, a computer system for broadcasting audio messages is disclosed. The computer system can include at least one processor. A non-transitory computer readable medium can embody executable instructions that can be configured when executed by one or more of the at least one processor to record one or more audio messages from a member of a social networking site. The audio message(s) can be stored in a library accessible only to the member. A selection can be received from the member of at least one of the one or more audio messages from the library. The selected audio message(s) can be associated with an account of the member. The selected audio message(s) can be broadcasted from the account of the member to at least one user of the social networking site when the user accesses the account of the member.

In accordance with another aspect of the disclosed subject matter, a computer network for broadcasting audio messages is disclosed. The computer network can include a communication interface. One or more processors can be connected to the communication interface. One or more computer readable storage media can be connected to the communication interface and to one or more of the processors. The computer readable storage media can embody executable instructions that can be configured when executed by one or more of the processors to record one or more audio messages from a member of a social networking site. The audio message(s) can be stored in a library accessible only to the member. A selection can be received from the member of at least one of the one or more audio messages from the library. The selected audio message(s) can be associated with an account of the member. The selected audio message(s) can be broadcasted from the account of the member to at least one user of the social networking site when the user accesses the account of the member.

In accordance with another aspect of the disclosed subject matter, a method for broadcasting audio messages is disclosed. The method can include recording one or more audio messages from a member of a social networking site. The audio message(s) can be stored in a library accessible only to the member. A selection can be received from the member of at least one of the one or more audio messages from the library. The selected audio message(s) can be associated with an account of the member. The selected audio message(s) can be broadcasted from the account of the member to at least one user of the social networking site when the user accesses the account of the member.

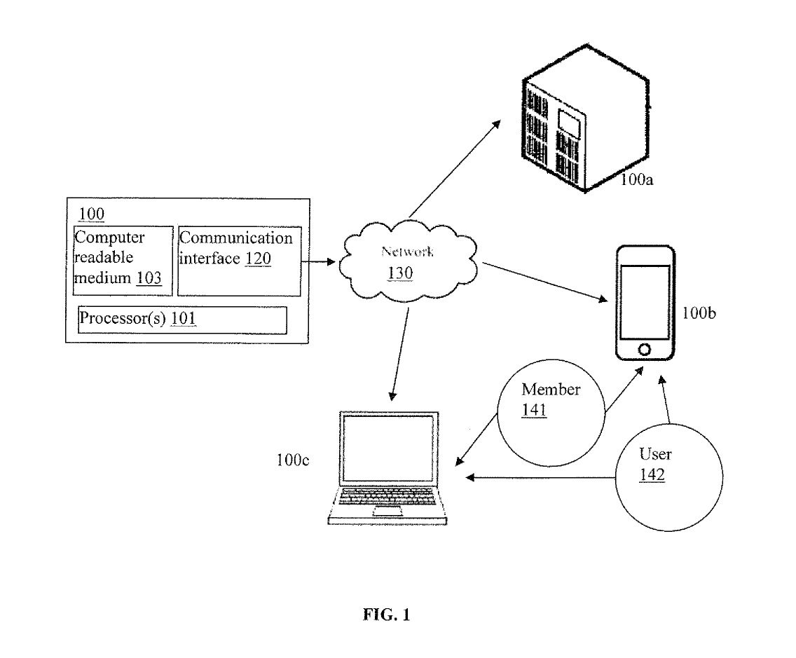

The accompanying figures, where like reference numerals refer to identical or functionally similar elements throughout the separate views, further illustrate various embodiments and explain various principles and advantages all in accordance with the disclosed subject matter. For purpose of explanation and illustration, and not limitation, exemplary embodiments of media, systems, networks, and methods for broadcasting audio messages in accordance with the disclosed subject matter are shown in FIGS. 1-3. While the present disclosed subject matter is described with respect to using the media, systems, networks, and methods for broadcasting audio messages, one skilled in the art will recognize that the disclosed subject matter is not limited to the illustrative embodiment. For example, the systems and methods for media, systems, networks, and methods for broadcasting audio messages can be used with a wide variety of settings such as websites, computer applications (“apps”), smartphone apps, tablet apps, apps for other mobile devices, and other suitable settings for broadcasting audio messages.

FIG. 1 is a diagram showing an exemplary system and network according to an illustrative embodiment of the disclosed subject matter. For example and not limitation, a computer network for broadcasting audio messages can include a system 100. The system 100 can include any suitable system, including but not limited to a computer system, a server, a personal computer, a mobile device such as a smartphone (e.g. iPhone, Android phone, or Windows phone) or tablet (e.g. iPad, Android tablet, or Windows tablet), or a combination of any suitable number of the aforementioned devices, as discussed herein. The system 100 can include a communication interface 120, one or more processors 101 connected to the communication interface 120, and one or more computer readable storage media 103 connected to the communication interface 120 and to one or more of the processors 101, The communication interface 120 can be any suitable interface including a network interface, a wired connection, or a wireless connection, as discussed herein. The processor(s) 101 can be any suitable processors, as discussed herein. The computer readable medium 103 can be any suitable computer readable medium, including but not limited to a memory, a hard drive, a mass storage device, and/or an integrated circuit, as discussed herein. The computer readable medium 103 can embody executable instructions, as discussed herein.

For purpose of illustration and not limitation, the system 100 can be connected to a network 130. For example and not limitation, the system 100 can be connected to the network 130 through the communication interface 120. The network 130 can be connected to any number of devices including, but not limited to computers, other computer systems, or other networks. As depicted in FIG. 1, the network 130 is connected to the system 100 and three additional devices: server 100a, smartphone 100b, and laptop computer 100c. As embodied herein, more or fewer additional devices 100a, 100b, 100c can be included, and the additional devices 100a, 100b, 100c can be any type of device, as discussed herein. Any or all of the devices can be functionally identical to the system 100. Additionally or alternatively, any or all of the additional devices 100a, 100b, 100c can be functionally different than system 100. For purpose of illustration and not limitation, the additional devices 100a, 100b, 100e can allow a user 142 to access the system 100 via the network 130. Additionally or alternatively, a user 142 can access the system 100 directly, for example, through input and/or output devices, as discussed herein. The user 142 can be the member 141 of the social networking site or any other user 142, as discussed herein. Additionally or alternatively, the user 142 can be another registered user of the social networking site or an unregistered user.

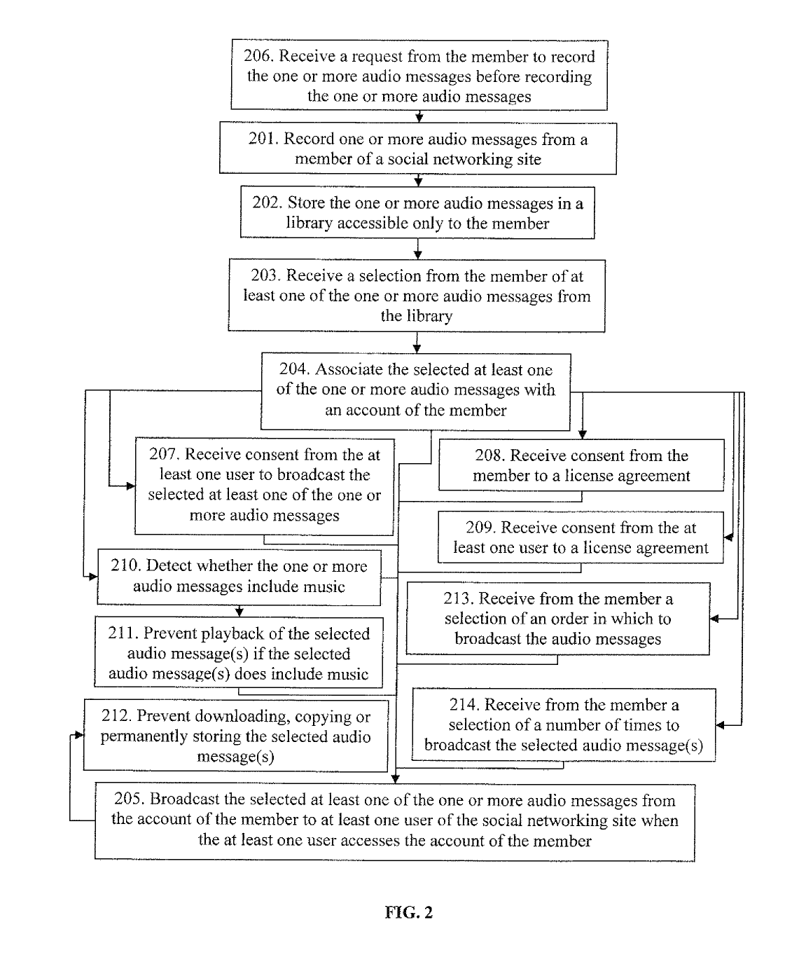

For purpose of illustration and not limitation, reference is made to the exemplary embodiment of the method as depicted in FIG. 2, with reference to FIG. 1. For example and not limitation, the executable instructions of the computer readable medium 103 can direct the processor(s) 101 of the system 100 to perform any or all of the following method steps in any suitable order. The system 100 can record one or more audio messages from a member 141 of a social networking site (201). The audio messages can be recorded using any suitable recording device, including but not limited to a microphone (internal or external), a smartphone, a tablet, or software and/or hardware adapted to create audio messages. As used herein, audio messages can include any audio content. For example and not limitation, audio content can include without limitation music, spoken words, sound recordings, and/or soundtracks associated with a video.

As embodied herein, the system 100 can store the audio message(s) in a library accessible only to the member 141 (202). As used herein, a library can be any suitable collection of audio messages including but not limited to a database, a list, a plurality of audio messages stored in one or more memories, and/or a plurality of audio messages stored in one or more mass storage devices. Additionally, the system 100 can receive a selection from the member 141 of at least one of the one or more audio messages from the library (203). The system can associate the selected audio message(s) with an account of the member 141 (204). For example and not limitation, the audio messages can be associated with the member's 141 account (204) for an unlimited period of time. Additionally or alternatively, the audio messages can be associated with the account (204) for a limited period of time. For purpose of illustration and not limitation, the association of the item(s) with the account can be based on general settings selected by the user to apply to all audio messages in the account, specific settings selected by the user to apply to specific audio messages in the account, and/or general settings of the system 100 to apply to all audio messages.

The selected audio message(s) can be broadcasted from the account of the member 141 to at least one user 142 of the social networking site when the user 142 accesses the account of the member (205). As discussed herein, the user 142 can be the member 141 of the social networking site, another registered user 142 of the social networking site, or any other user 142 (e.g. an unregistered user 142). For purpose of illustration and not limitation, the broadcasting (205) can be limited to registered users of the social networking site.

For example and not limitation, the system 100 can receive a request from the member 142 to record the audio message(s) (206) before recording the audio message(s) (201). For purpose of illustration and not limitation, receiving a request (206) can include receiving an indication that the member 141 has interacted with at least one element to access the library of audio messages. For example and not limitation, the element can be at least one of a link, a button, an icon, or a keyboard. For purpose of illustration and not limitation, the element can in integrated into the website or interface of the social networking site such that the appearance and functionality of the interface is substantially unchanged except for the addition of the element. Additionally or alternatively, the request (206), recording of the audio message(s) (201), storing of the audio message(s) (202), selection of the audio message(s) (203), association of the audio message(s) with the member's 141 account (204), and/or broadcasting (205) can be performed through a separate website or separate application, for example, a smartphone app or tablet app.

For purpose of illustration and not limitation, the system 100 can receive consent from the at least one user 142 to broadcast the selected audio message(s) (207). For example and not limitation, receiving consent can include receiving an indication that the user 142 has interacted with at least one element, as discussed herein. Additionally or alternatively, the system 100 can receive consent from the member 141 to a license agreement (208). For example and not limitation, the license agreement for the member 141 can include at least one of a license for the member 141 to use software to record (201), store (202), select (203), associate (204) and/or broadcast (205) the audio message(s) and a license for the social networking site and a software provider to broadcast (205) the audio message(s). Additionally or alternatively, the system 100 can receive consent from the at least one user 142 to a license agreement (209). For purpose of illustration and not limitation, the license agreement for the user 142 can include the consent to broadcast the selected audio message(s) to the user 142, as discussed herein, and/or a license for the user 142 to use software to broadcast (205) the audio message(s). For purpose of illustration and not limitation, the appropriate software to broadcast the audio messages can be included in the system 100, the executable instructions, separate hardware and software, or a combination thereof. For purpose of illustration and not limitation, no right or title to the audio messages can be transferred from the member 141 and/or to the users 142, social networking site, or software provider other than the aforementioned license(s).

As embodied herein, the system 100 can detect whether the audio message(s) include music (210). For example and not limitation, detecting whether the audio message(s) include music (210) can include using voice recognition to determine whether the audio message(s) include music. Additionally, broadcasting the selected audio message(s) (205) can include broadcasting the selected audio message(s) only if the selected at least one audio message does not include music. Additionally or alternatively, the system 100 can prevent playback of the selected audio message(s) if the selected audio message(s) include music (211). Additionally, the member 141 can be precluded from recording (201) and/or broadcasting (205) audio messages that include music by the terms of the aforementioned license(s). For purpose of illustration and not limitation, the member 141 can be temporarily or permanently banned from recording (201) and/or broadcasting (205) audio messages through the system 100 if the member 141 attempts to record (201) and/or broadcast (205) audio messages that include music under certain conditions. For example and not limitation, the system 100 can ban the member 141 temporarily each time the member makes such an attempt. Additionally or alternatively, the system 100 can count, measure, or otherwise track when the member 141 attempts to record (201) and/or broadcast (205) audio messages that include music. If the member 141 makes such attempts more than a predetermined number of times, makes such attempts too often in a predefined period of time, or some other criterion is met (e.g. an audio message that consists entirely of music), the system 100 can ban the member 141 temporarily or permanently.

For purpose of illustration and not limitation, broadcasting the selected audio message(s) (205) can include streaming the selected audio message(s) without downloading or permanently storing the selected audio message(s). Additionally or alternatively, the system 100 can prevent downloading, copying or permanently storing the selected audio message(s) (212). For example and not limitation, preventing downloading, copying, or permanently storing the audio message(s) (212) can include using encryption. Additionally or alternatively, other suitable security features can be employed for such prevention. Additionally, the member 141 and/or the user 142 can be precluded from downloading, copying, or permanently storing by the terms of the aforementioned license(s).

As embodied herein, the selected audio message(s) can include a plurality of audio messages. Additionally, the system 100 can receive from the member 141 a selection of an order in which to broadcast the plurality of audio messages (213). Additionally or alternatively, the system 100 can broadcast the audio messages in a predetermined order, a random order, or no order at all. For example and not limitation, each selected audio message can broadcast (205) one time each time a user 142 accesses the member's 141 account. Additionally or alternatively, each item of audio messages can play more than once. For example and not limitation, the system 100 can receive from the member 141 a selection of a number of times to broadcast the selected audio message(s) (214). For purpose of illustration and not limitation, the member 141 can select a number of times for each audio message to be played, select that a plurality of audio messages be played in order for a selected number of times, and/or select that one or more audio messages be played continuously on repeat.

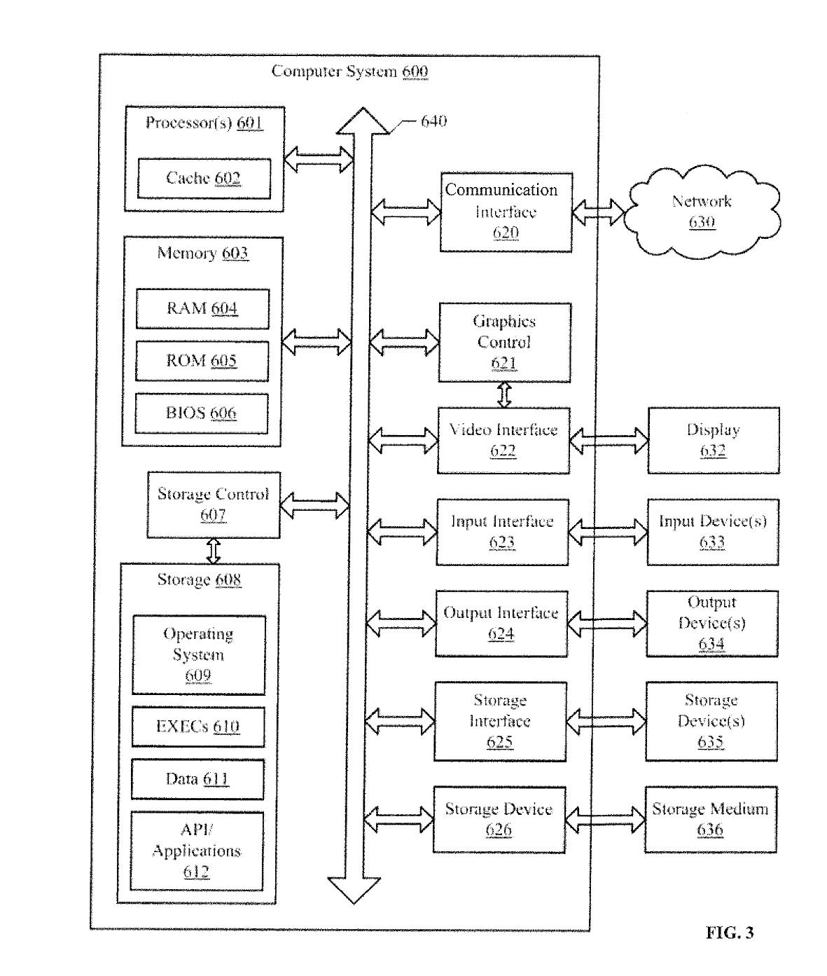

The systems and techniques discussed herein can be implemented in a computer system. As an example and not by limitation, as shown in FIG. 3, the computer system having architecture 600 can provide functionality as a result of processor(s) 601 executing software embodied in one or more tangible, non-transitory computer-readable media, such as memory 603. The software implementing various embodiments of the present disclosure can be stored in memory 603 and executed by processor(s) 601. A computer-readable medium can include one or more memory devices, according to particular needs. Memory 603 can read the software from one or more other computer-readable media, such as mass storage device(s) 635 or from one or more other sources via communication interface 620. The software can cause processor(s) 601 to execute particular processes or particular parts of particular processes described herein, including defining data structures stored in memory 603 and modifying such data structures according to the processes defined by the software. An exemplary input device 633 can be, for example, a keyboard, a pointing device (e.g. a mouse), a touchscreen display, a microphone and voice control interface, or the like to capture user input coupled to the input interface 623 to provide data and/or user input to the processor 601. An exemplary output device 634 can be, for example, a display (e.g. a monitor) or speakers coupled to the output interface 623 to allow the processor 601 to present a user interface, visual content, and/or audio content. Additionally or alternatively, the computer system 600 can provide an indication to the user by sending text or graphical data to a display 632 coupled to a video interface 622. Furthermore, any of the above components can provide data to or receive data from the processor 601 via a computer network 630 coupled the communication interface 620 of the computer system 600. In addition or as an alternative, the computer system can provide functionality as a result of logic hardwired or otherwise embodied in a circuit, which can operate in place of or together with software to execute particular processes or particular parts of particular processes described herein. Reference to software or executable instructions can encompass logic, and vice versa, where appropriate. Reference to a computer-readable media can encompass a circuit (such as an integrated circuit (IC)) storing software or executable instructions for execution, a circuit embodying logic for execution, or both, where appropriate. The present disclosure encompasses any suitable combination of hardware and software.

In some embodiments, processor 601 includes hardware for executing instructions, such as those making up a computer program. As an example and not by way of limitation, to execute instructions, processor 601 can retrieve (or fetch) the instructions from an internal register, an internal cache 602, memory 603, or storage 608; decode and execute them; and then write one or more results to an internal register, an internal cache 602, memory 603, or storage 608. In particular embodiments, processor 601 can include one or more internal caches 602 for data, instructions, or addresses. This disclosure contemplates processor 601 including any suitable number of any suitable internal caches, where appropriate. As an example and not by way of limitation, processor 601 can include one or more instruction caches 602, one or more data caches 602, and one or more translation lookaside buffers (TLBs). Instructions in the instruction caches 602 can be copies of instructions in memory 603 or storage 608, and the instruction caches 602 can speed up retrieval of those instructions by processor 601. Data in the data caches 602 can be copies of data in memory 603 or storage 608 for instructions executing at processor 601 to operate on; the results of previous instructions executed at processor 601 for access by subsequent instructions executing at processor 601 or for writing to memory 603 or storage 608; or other suitable data. The data caches 602 can speed up read or write operations by processor 601. The TLBs can speed up virtual-address translation for processor 601. In some embodiments, processor 601 can include one or more internal registers for data, instructions, or addresses. This disclosure contemplates processor 601 including any suitable number of any suitable internal registers, where appropriate. Where appropriate, processor 601 can include one or more arithmetic logic units (ALUs); be a multi-core processor; or include one or more processors 601. Although this disclosure describes and illustrates a particular processor, this disclosure contemplates any suitable processor.

In some embodiments, memory 603 includes main memory for storing instructions for processor 601 to execute or data for processor 601 to operate on. As an example and not by way of limitation, computer system 600 can load instructions from storage 608 or another source (such as, for example, another computer system 600) to memory 603. Processor 601 can then load the instructions from memory 603 to an internal register or internal cache 602. To execute the instructions, processor 601 can retrieve the instructions from the internal register or internal cache 602 and decode them. During or after execution of the instructions, processor 601 can write one or more results (which can be intermediate or final results) to the internal register or internal cache 602. Processor 601 can then write one or more of those results to memory 603. In some embodiments, processor 601 executes only instructions in one or more internal registers or internal caches 602 or in memory 603 (as opposed to storage 608 or elsewhere) and operates only on data in one or more internal registers or internal caches or in memory 603 (as opposed to storage 608 or elsewhere). One or more memory buses (which can each include an address bus and a data bus) can couple processor 601 to memory 603. Bus 640 can include one or more memory buses, as described below. In particular embodiments, one or more memory management units (MMUs) reside between processor 601 and memory 603 and facilitate accesses to memory 603 requested by processor 601. In some embodiments, memory 603 includes random access memory (RAM). This RAM can be volatile memory, where appropriate. Where appropriate, this RAM can be dynamic RAM (DRAM) or static RAM (SRAM). Moreover, where appropriate, this RAM can be single-ported or multi-ported RAM. This disclosure contemplates any suitable RAM. Memory 603 can include one or more memories 304, where appropriate. Although this disclosure describes and illustrates particular memory, this disclosure contemplates any suitable memory.

In some embodiments, storage 608 includes mass storage for data or instructions. As an example and not by way of limitation, storage 608 can include a hard disk drive (HDD), a floppy disk drive, flash memory, an optical disc, a magneto-optical disc, magnetic tape, or a Universal Serial Bus (USB) drive or a combination of two or more of these. Storage 608 can include removable or non-removable (or fixed) media, where appropriate. Storage 608 can be internal or external to computer system 600, where appropriate. In some embodiments, storage 608 is non-volatile, solid-state memory. In some embodiments, storage 608 includes read-only memory (ROM). Where appropriate, this ROM can be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 608 taking any suitable physical form. Storage 608 can include one or more storage control units facilitating communication between processor 601 and storage 608, where appropriate. Where appropriate, storage 608 can include one or more storages 608. Although this disclosure describes and illustrates particular storage, this disclosure contemplates any suitable storage.

In some embodiments, input interface 623 and output interface 624 can include hardware, software, or both, providing one or more interfaces for communication between computer system 600 and one or more input device(s) 633 and/or output device(s) 634. Computer system 600 can include one or more of these input device(s) 633 and/or output device(s) 634, where appropriate. One or more of these input device(s) 633 and/or output device(s) 634 can enable communication between a person (e.g. member 141 and/or user 142) and computer system 600. As an example and not by way of limitation, an input device 633 and/or output device 634 can include a keyboard, keypad, microphone, monitor, mouse, printer, scanner, speaker, still camera, stylus, tablet, touch screen, trackball, video camera, another suitable input device 633 and/or output device 634 or a combination of two or more of these. An input device 633 and/or output device 634 can include one or more sensors. This disclosure contemplates any suitable input device(s) 633 and/or output device(s) 634 and any suitable input interface 623 and output interface 624 for them. Where appropriate, input interface 623 and output interface 624 can include one or more device or software drivers enabling processor 601 to drive one or more of these input device(s) 633 and/or output device(s) 634. Input interface 623 and output interface 624 can include one or more input interfaces 623 or output interfaces 624, where appropriate. Although this disclosure describes and illustrates a particular input interface 623 and output interface 624, this disclosure contemplates any suitable input interface 623 and output interface 624.

As embodied herein, communication interface 620 can include hardware, software, or both providing one or more interfaces for communication (such as, for example, packet-based communication) between computer system 600 and one or more other computer systems 600 or one or more networks. As an example and not by way of limitation, communication interface 620 can include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 620 for it. As an example and not by way of limitation, computer system 600 can communicate with an ad hoc network, a personal area network (PAN), a local area network (LAN), a wide area network (WAN), a metropolitan area network (MAN), or one or more portions of the Internet or a combination of two or more of these. One or more portions of one or more of these networks can be wired or wireless. As an example, computer system 600 can communicate with a wireless PAN (WPAN) (such as, for example, a BLUETOOTH WPAN), WI-FI network, a WI-MAX network, a cellular telephone network (such as, for example, a Global System for Mobile Communications (GSM) network), or other suitable wireless network or a combination of two or more of these. Computer system 600 can include any suitable communication interface 620 for any of these networks, where appropriate. Communication interface 620 can include one or more communication interfaces 620, where appropriate. Although this disclosure describes and illustrates a particular communication interface, this disclosure contemplates any suitable communication interface.

In some embodiments, bus 640 includes hardware, software, or both coupling components of computer system 600 to each other. As an example and not by way of limitation, bus 640 can include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 640 can include one or more buses 604, where appropriate. Although this disclosure describes and illustrates a particular bus, this disclosure contemplates any suitable bus or interconnect.

Herein, a computer-readable non-transitory storage medium or media can include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium can be volatile, non-volatile, or a combination of volatile and non-volatile, where appropriate.

While the disclosed subject matter is described herein in terms of certain preferred embodiments, those skilled in the art will recognize that various modifications and improvements can be made to the disclosed subject matter without departing from the scope thereof. Moreover, although individual features of one embodiment of the disclosed subject matter can be discussed herein or shown in the drawings of the one embodiment and not in other embodiments, it should be apparent that individual features of one embodiment can be combined with one or more features of another embodiment or features from a plurality of embodiments.

In addition to the specific embodiments claimed below, the disclosed subject matter is also directed to other embodiments having any other possible combination of the dependent features claimed below and those disclosed above. As such, the particular features presented in the dependent claims and disclosed above can be combined with each other in other manners within the scope of the disclosed subject matter such that the disclosed subject matter should be recognized as also specifically directed to other embodiments having any other possible combinations. Thus, the foregoing description of specific embodiments of the disclosed subject matter has been presented for purposes of illustration and description. It is not intended to be exhaustive or to limit the disclosed subject matter to those embodiments disclosed.

As embodied herein, for purpose of illustration and not limitation, a social networking-based product is created and provided. The disclosed subject matter provides advanced features and functionality including but not limited to allowing customization of a member's social networking profile, broadcasting audio messages automatically while a user is viewing a member's social networking profile, recording personalized audio messages, and detecting whether audio messages include music. Additionally, for example and not limitation, the social networking site and the computer systems and devices that access the social networking site are enhanced by the provision of the new social networking-based products disclosed herein, which include novel features and functionality that otherwise would not be available. Indeed, the field of broadcasting audio messages is also improved by the provision of the new products disclosed herein and the novel features and functionality thereof.

It will be apparent to those skilled in the art that various modifications and variations can be made in the method and system of the disclosed subject matter without departing from the spirit or scope of the disclosed subject matter. Thus, it is intended that the disclosed subject matter include modifications and variations that are within the scope of the appended claims and their equivalents.

What is claimed is:

1. A non-transitory computer readable storage medium comprising a set of executable instructions to direct a processor to:
record one or more audio messages from a member of a social networking site;
store the one or more audio messages in a library accessible only to the member;
receive a selection from the member of at least one of the one or more audio messages from the library;
associate the selected at least one of the one or more audio messages with an account of the member; and
broadcast the selected at least one of the one or more audio messages from the account of the member to at least one user of the social networking site when the at least one user accesses the account of the member.

2. The non-transitory computer readable storage medium of claim 1, further comprising executable instructions to direct the processor to receive a request from the member to record the one or more audio messages before recording the one or more audio messages.

3. The non-transitory computer readable storage medium of claim 2, wherein receive a request comprises receive an indication that the member has interacted with at least one element.

4. The non-transitory computer readable storage medium of claim 3, wherein the element is at least one of a link, a button, an icon, or a keyboard.

5. The non-transitory computer readable storage medium of claim 1, further comprising executable instructions to direct the processor to receive consent from the at least one user to broadcast the selected at least one of the one or more audio messages.

6. The non-transitory computer readable storage medium of claim 1, further comprising executable instructions to direct the processor to receive consent from the member to a license agreement.

7. The non-transitory computer readable storage medium of claim 6, wherein the license agreement includes a license for the member to use software to record and broadcast the audio messages and a license for the social networking site and a software provider to broadcast the audio messages.

8. The non-transitory computer readable storage medium of claim 1, further comprising executable instructions to direct the processor to receive consent from the at least one user to a license agreement.

9. The non-transitory computer readable storage medium of claim 1, further comprising executable instructions to direct the processor to detect whether the one or more audio messages include music, and wherein broadcast the selected at least one of the one or more audio messages comprises broadcast the selected at least one of the one or more audio messages if the selected at least one of the one or more audio messages does not include music.

10. The non-transitory computer readable medium of claim 9, wherein detect whether the one or more audio messages include music comprises use voice recognition to determine whether the one or more audio messages include music.

11. The non-transitory computer readable storage medium of claim 9, further comprising executable instructions to direct the processor to prevent playback of the selected at least one of the one or more audio messages if the selected at least one of the one or more audio messages does include music.

12. The non-transitory computer readable storage medium of claim 1, wherein broadcast the selected at least one of the one or more audio messages comprises stream the selected at least one of the one or more audio messages without downloading or permanently storing the selected at least one of the one or more audio messages.

13. The non-transitory computer readable storage medium of claim 1, further comprising executable instructions to direct the processor to prevent downloading, copying or permanently storing the selected at least one of the one or more audio messages.

14. The non-transitory computer readable storage medium of claim 13, wherein prevent downloading, copying, or permanently storing the selected at least one of the one or more audio messages comprises using encryption.

15. The non-transitory computer readable storage medium of claim 1, wherein the selected at least one of the one or more audio messages comprises a plurality of audio messages.

16. The non-transitory computer readable storage medium of claim 15, further comprising executable instructions to direct the processor to receive from the member a selection of an order in which to broadcast the plurality of audio messages.

17. The non-transitory computer readable storage medium of claim 1, further comprising executable instructions to direct the processor to receive from the member a selection of a number of times to broadcast the selected at least one of the one or more audio messages.

18. A computer system for broadcasting audio messages, comprising:
at least one processor; and
a non-transitory computer readable medium embodying software that is configured when executed by one or more of the at least one processor to:
record one or more audio messages from a member of a social networking site;
store the one or more audio messages in a library accessible only to the member;
receive a selection from the member of at least one of the one or more audio messages from the library;
associate the selected at least one of the one or more audio messages with an account of the member; and
broadcast the selected at least one of the one or more audio messages from the account of the member to at least one user of the social networking site when the at least one user accesses the account of the member.

19. The system of claim 18, further comprising executable instructions to direct the processor to receive a request from the member to record the one or more audio messages before recording the one or more audio messages.

20. The system of claim 19, wherein receive a request comprises receive an indication that the member has interacted with at least one element.

21. The system of claim 20, wherein the element is at least one of a link, a button, an icon, or a keyboard.

22. The system of claim 18, further comprising executable instructions to direct the processor to receive consent from the at least one user to broadcast the selected at least one of the one or more audio messages.

23. The system of claim 18, further comprising executable instructions to direct the processor to receive consent from the member to a license agreement.

24. The system of claim 23, wherein the license agreement includes a license for the member to use software to record and broadcast the audio messages and a license for the social networking site and a software provider to broadcast the audio messages.

25. The system of claim 18, further comprising executable instructions to direct the processor to receive consent from the at least one user to a license agreement.

26. The system of claim 18, further comprising executable instructions to direct the processor to detect whether the one or more audio messages include music, and wherein broadcast the selected at least one of the one or more audio messages comprises broadcast the selected at least one of the one or more audio messages if the selected at least one of the one or more audio messages does not include music.

27. The system of claim 26, wherein detect whether the one or more audio messages include music comprises use voice recognition to determine whether the one or more audio messages include music.

28. The system of claim 26, further comprising executable instructions to direct the processor to prevent playback of the selected at least one of the one or more audio messages if the selected at least one of the one or more audio messages does include music.

29. The system of claim 18, wherein broadcast the selected at least one of the one or more audio messages comprises stream the selected at least one of the one or more audio messages without downloading or permanently storing the selected at least one of the one or more audio messages.

30. The system of claim 18, further comprising executable instructions to direct the processor to prevent downloading, copying or permanently storing the selected at least one of the one or more audio messages.

31. The system of claim 30, wherein prevent downloading, copying, or permanently storing the selected at least one of the one or more audio messages comprises using encryption.

32. The system of claim 18, wherein the selected at least one of the one or more audio messages comprises a plurality of audio messages.

33. The system of claim 32, further comprising executable instructions to direct the processor to receive from the member a selection of an order in which to broadcast the plurality of audio messages.

34. The system of claim 18, further comprising executable instructions to direct the processor to receive from the member a selection of a number of times to broadcast the selected at least one of the one or more audio messages.

35. A computer network for broadcasting audio messages, comprising:
a communication interface;
one or more processors connected to the communication interface; and
one or more computer readable storage media connected to the communication interface and to one or more of the processors, and embodying software that is configured when executed by one or more of the processors to:
record one or more audio messages from a member of a social networking site;
store the one or more audio messages in a library accessible only to the member;
receive a selection from the member of at least one of the one or more audio messages from the library;
associate the selected at least one of the one or more audio messages with an account of the member; and
broadcast the selected at least one of the one or more audio messages from the account of the member to at least one user of the social networking site when the at least one user accesses the account of the member.

36. The computer network of claim 35, further comprising executable instructions to direct the processor to receive a request from the member to record the one or more audio messages before recording the one or more audio messages.

37. The computer network 36, wherein receive a request comprises receive an indication that the member has interacted with at least one element.

38. The computer network of claim 37, wherein the element is at least one of a link, a button, an icon, or a keyboard.

39. The computer network of claim 35, further comprising executable instructions to direct the processor to receive consent from the at least one user to broadcast the selected at least one of the one or more audio messages.

40. The computer network of claim 35, further comprising executable instructions to direct the processor to receive consent from the member to a license agreement.

41. The computer network of claim 40, wherein the license agreement includes a license for the member to use software to record and broadcast the audio messages and a license for the social networking site and a software provider to broadcast the audio messages.

42. The computer network of claim 35, further comprising executable instructions to direct the processor to receive consent from the at least one user to a license agreement.

43. The computer network of claim 35, further comprising executable instructions to direct the processor to detect whether the one or more audio messages include music, and wherein broadcast the selected at least one of the one or more audio messages comprises broadcast the selected at least one of the one or more audio messages if the selected at least one of the one or more audio messages does not include music.

44. The computer network of claim 43, wherein detect whether the one or more audio messages include music comprises use voice recognition to determine whether the one or more audio messages include music.

45. The computer network of claim 43, further comprising executable instructions to direct the processor to prevent playback of the selected at least one of the one or more audio messages if the selected at least one of the one or more audio messages does include music.

46. The computer network of claim 35, wherein broadcast the selected at least one of the one or more audio messages comprises stream the selected at least one of the one or more audio messages without downloading or permanently storing the selected at least one of the one or more audio messages.

47. The computer network of claim 35, further comprising executable instructions to direct the processor to prevent downloading, copying or permanently storing the selected at least one of the one or more audio messages.

48. The computer network of claim 47, wherein prevent downloading, copying, or permanently storing the selected at least one of the one or more audio messages comprises using encryption.

49. The computer network of claim 35, wherein the selected at least one of the one or more audio messages comprises a plurality of audio messages.

50. The computer network of claim 49, further comprising executable instructions to direct the processor to receive from the member a selection of an order in which to broadcast the plurality of audio messages.

51. The computer network of claim 35, further comprising executable instructions to direct the processor to receive from the member a selection of a number of times to broadcast the selected at least one of the one or more audio messages.

52. A method for broadcasting audio messages, comprising:
recording one or more audio messages from a member of a social networking site;
storing the one or more audio messages in a library accessible only to the member;
receiving a selection from the member of at least one of the one or more audio messages from the library;
associating the selected at least one of the one or more audio messages with an account of the member; and
broadcasting the selected at least one of the one or more audio messages from the account of the member to at least one user of the social networking site when the at least one user accesses the account of the member.

53. The method of claim 52, further comprising receiving a request from the member to record the one or more audio messages before recording the one or more audio messages.

54. The method of claim 53, wherein receive a request comprises receive an indication that the member has interacted with at least one element.

55. The method of claim 54, wherein the element is at least one of a link, a button, an icon, or a keyboard.

56. The method of claim 52, further comprising receiving consent from the at least one user to broadcast the selected at least one of the one or more audio messages.

57. The method of claim 52, further comprising receiving consent from the member to a license agreement.

58. The method of claim 57, wherein the license agreement includes a license for the member to use software to record and broadcast the audio messages and a license for the social networking site and a software provider to broadcast the audio messages.

59. The method of claim 52, further comprising receiving consent from the at least one user to a license agreement.

60. The method of claim 52, further comprising detecting whether the one or more audio messages include music, and wherein broadcasting the selected at least one of the one or more audio messages comprises broadcast the selected at least one of the one or more audio messages if the selected at least one of the one or more audio messages does not include music.

61. The method of claim 60, wherein detecting whether the one or more audio messages include music comprises using voice recognition to determine whether the one or more audio messages include music.

62. The method of claim 60, further comprising preventing playback of the selected at least one of the one or more audio messages if the selected at least one of the one or more audio messages does include music.

63. The method of claim 52, wherein broadcasting the selected at least one of the one or more audio messages comprises streaming the selected at least one of the one or more audio messages without downloading or permanently storing the selected at least one of the one or more audio messages.

64. The method of claim 52, further comprising preventing downloading, copying or permanently storing the selected at least one of the one or more audio messages.

65. The method of claim 64, wherein prevent downloading, copying, or permanently storing the selected at least one of the one or more audio messages comprises using encryption.

66. The method of claim 52, wherein the selected at least one of the one or more audio messages comprises a plurality of audio messages.

67. The method of claim 66, further comprising receiving from the member a selection of an order in which to broadcast the plurality of audio messages.

68. The method of claim 52, further comprising receiving from the member a selection of a number of times to broadcast the selected at least one of the one or more audio messages.
